(19) United States
(12) Patent Application Publication
(10) Pub. No.: US 2007/0134973 A1
(43) Pub. Date: Jun. 14, 2007

(54) Cablecure, a guitar accessory

(76) Inventor: John Coco, Elmont, NY (US)

Correspondence Address: John Coco;c/o A.L. Liebman, Bldg #3, 50 Carnation Ave, Floral Park, NY, 11001, US

(21) Appl. No.: 11/640,406

(22) Filed: Dec. 14, 2006

Related U.S. Application Data
(60) Provisional application No. 60/750,165, filed on Dec. 14, 2005.

(51) Int. Cl. H01R 4/24

(52) U.S. Cl. 439/404

(57) ABSTRACT

A guitar accessory that's comprised of a flat base (10), radial sequence of channels (28) projections on the top side of the channels (24) channel guides (30), mounting hole (12), Patch Cable strain relief guides (34) and a guitar pick holder (26).

### CROSS-REFERENCE TO RELATED APPLICATIONS

U.S. Application No. 60/750,165

Filing Date: Dec. 14, 2005

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to accessories for guitars, specifically those that are used to guide and lead electric amplifier cables to and from the guitar.

2. Background of the Invention

Electric cables (Patch Cables) are used to connect an electric or an acoustic guitar or bass guitar with amplification capabilities. The patch cable transmits electro magnetic signals in the form of electric current to the amplifier which in turn emits sound. The patch cable is connected to the guitar body via a metal plug that is inserted into a metal receptacle (commonly referred to as a jack). The receptacle (jack) location varies depending on the style, make and model of the guitar. The other end of the patch cable also has a metal plug, which is inserted into a metal receptacle located on the amplifier or other amplification device such as a public announcement system.

Typically the patch cable is allowed to either dangle freely or it is fed over the end pin, strap button or the guitar strap itself.

The main disadvantages of dangling the patch cable are: It can become entangled in the players' feet as he moves around and if the patch cable is stepped on, the strain on the plug ends can loosen or tear them from the cable. Furthermore, the patch cable can be pulled from the guitar if the guitarist strays too far from the amplifier. Additionally, when the patch cable end is pulled or moved at the point where the metal plug mates with the metal receptacle (jack), it can cause a power surge, potentially damaging the amplifier and sound equipment. Further, any strain or tension placed at the site where the patch cable is inserted into the guitar receptacle (jack) can loosen or damage the guitar side receptacle (jack) and or the guitar body.

The main disadvantages of feeding the patch cable over the end pin or strap button or the guitar strap itself are: When this is done it creates a hard angle where the cable meets the plug end which causes potentially damaging strain. This is the most sensitive part of the patch cord assembly and most prone to breaking. Any tension on the patch cable would be transmitted directly to the cables' end and the mating receptacle. Furthermore, this method interferes with the strap and may cause abrasion or damage to the guitars finish. In addition, if strain is exerted onto the patch cable, it could pull the guitar strap off the end pin or strap button. Also, it takes two hands to feed the patch cable over the end pin or through the strap. Finally, when a patch cable is fed through the strap, there is no point of resistance to protect the receptacle (jack) on the guitar body.

### BACKGROUND OF INVENTION—OBJECTS AND ADVANTAGES

The objects and advantages of my new design are to prevent vertical and horizontal strain, or pulling on the patch cable ends, the guitar receptacle (jack) and the guitar strap. In addition, a channel pocket provides the guitarist with a holder for a guitar pick. The advantages are achieved through several specific characteristics that this design embodies.

a) Channels that capture and hold the patch cable in place.

b) Projections on the top side of these channels that permit the user to snap the patch cable securely into position

c) Flex gaps which enable the channels to accommodate different diameter patch cables

d) Channel guides which provide added strain reduction points

e) Channel shapes and positions that allow for one-handed patch cable insertion

f) Mounting holes in various diameters and/or a mounting hole surrounded by relief cuts that permit the invention to be mounted on different size end pins or strap buttons

g) Holding slots into which a guitar pick is inserted

h) Swivel hole that transfers strain from the patch cable onto the cablecure and it's ability to pivot around the pin on which it is mounted

i) Patch cable strain relief guides which provide tension reduction points for the patch cable

j) Manufactured with glass filled nylon that provides superior strength and flexibility in color choices

### SUMMARY

In accordance with the present innovation and introduction of this design, using the cablecure will hold and stabilize a patch cable, while minimizing any potential strain and damage to the guitar, patch cable ends, amplifier and electronic sound equipment.

### DRAWING—FIGURES

In the drawings, there are ten figures of the Cablecure. They are labeled numerically from 1 to 10.

FIG. 1 illustrates the front perspective view of the Cablecure

FIG. 2 illustrates the back perspective view of the Cabiecure

FIG. 3 illustrates the isometric perspective view of the Cablecure

FIG. 4 illustrates the projected perspective view of the Cablecure

FIG. 5 illustrates the bottom perspective view of the Cablecure

FIG. 6 illustrates the top perspective view of the Cablecure

FIG. 7 illustrates the right perspective view of the Cablecure

FIG. 8 illustrates the left perspective view of the Cablecure

FIG. 9 illustrates the perspective wiring route view of the Cablecure

FIG. 10 illustrates the perspective cutaway wiring view of the Cablecure

### DRAWINGS—REFERENCE NUMERALS

10 Rounded Base For Stress Reduction

12 Hole for Strap Button or End Pin

14 Front Patch Cable Channel Offset

16 Main Body/ Base

18 Side Flex Gap

20 Central Flex Gap

22 Counter-sunk Recess For The Strap Button or End Pin

24 Patch Cable Projections

26 Pick Holder

28 Radial Channels

30 Patch Cable Channel Guides

32 Patch Cable

34 Patch Cable strain relief guides

36 Areas Vulnerable To Deflection

38 Side Patch Cable Channel Offset

40 Patch Cable strain relief guides offset

### DETAILED DESCRIPTION

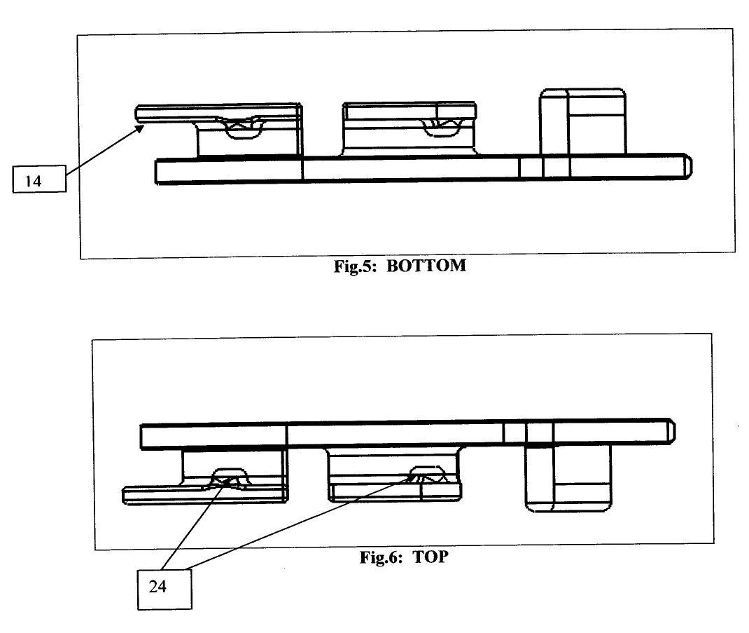

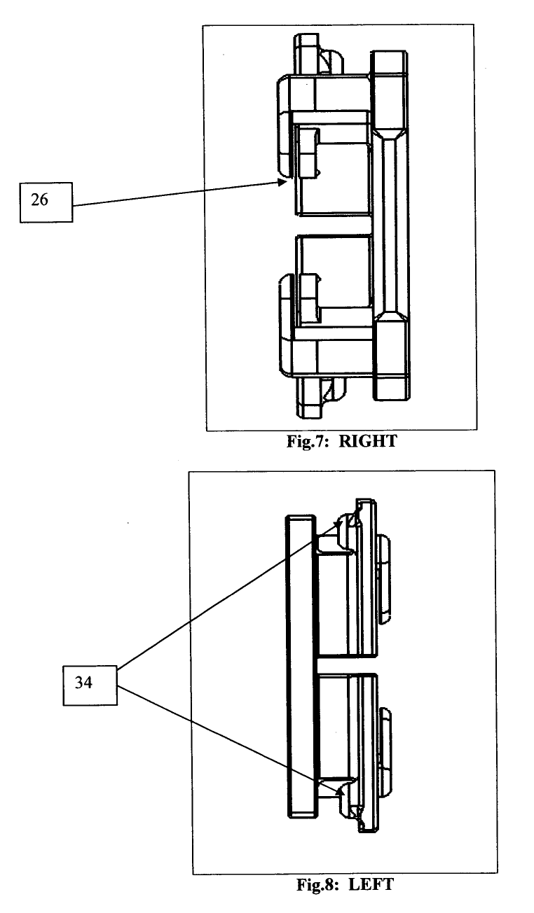

### FIGS. 1, 2, 5, 6, and 8—Preferred Embodiment

A preferred embodiment of the present invention is illustrated in FIGS. 1, 2, 5, 6 and 8. The Hole for Strap button or End Pin 12 is used to mount the CableCure to the guitar. There is a Counter-sunk recess for the Strap Button or End Pin 22 to be placed, to provide sufficient clearance when the guitar and CableCure are mounted together and stored in a guitar case. In order to accommodate the torque load and tensions that may be placed on the CableCure when in use, a Central Flex Gap 20 and a Side Flex Gap 18 were created to allow for slight deflection when the patch cable is tightened. The Central Flex Gap 20 and Side Flex Gap 18 also enable the cablecure to accommodate different diameter cables.

To enable the guitarist or person using the CableCure to be able to quickly snap on and off the guitar wire, three main features were implemented. The first feature is the Front Patch Cable Channel Offset 14 and Side Patch Cable Offset 38. These offsets guide the patch cable into the patch cable channels. The second is the Patch Cable strain relief tabs 34; these are made with ample height to sufficiently capture the patch cable with small projections incorporated on their underside.

The third feature is the Patch Cable Projection 24. The Patch Cable Projections are small rounded protrusions that can be found on the Radial Channel ends. They are positioned to provide sufficient clearance for the patch wire to be guided and snapped into the radial channels.

The aforementioned embodiments will be achieved by manufacturing the invention either through the injection molding process or by machining it from a block of material. To maintain strength, flexibility, minimal weight, range of color choices, and a non abrasive surface finish and texture, the invention will be produced using a plastic or rubber material.

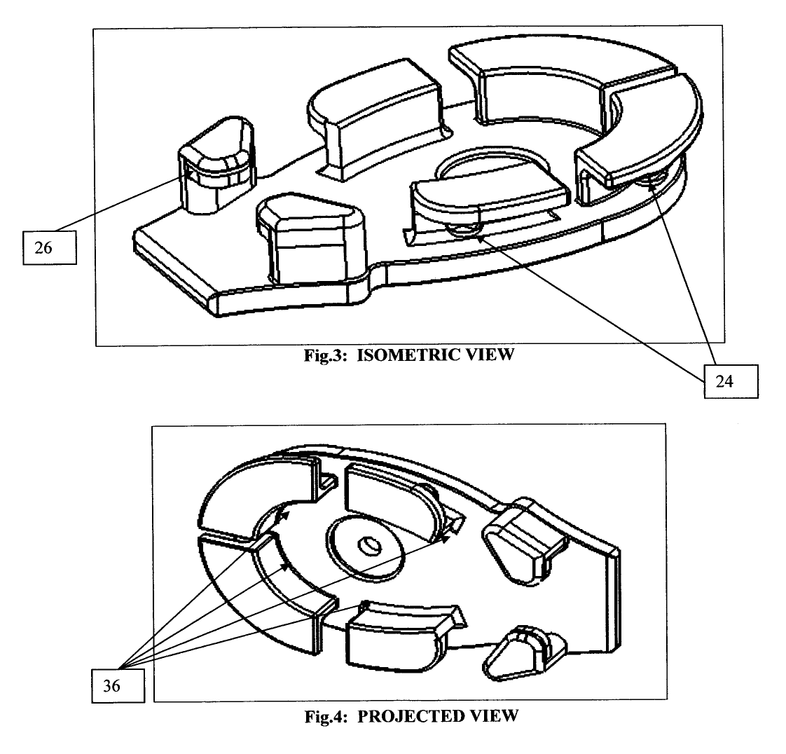

### FIGS. 3,4,7,9 and 10—Additional Embodiments

Additional embodiments are shown in FIGS. 3 and 4. In FIG. 3, the isometric view is illustrated. A key feature here is the pick holder 26, into which a pick is slid into the two slots incorporated into the patch cable strain relief tabs. In FIG. 4, the Areas Vulnerable to Deflection 36 are highlighted. In order to reduce stress and torque concentration, radiused edges and corners were incorporated in these areas.

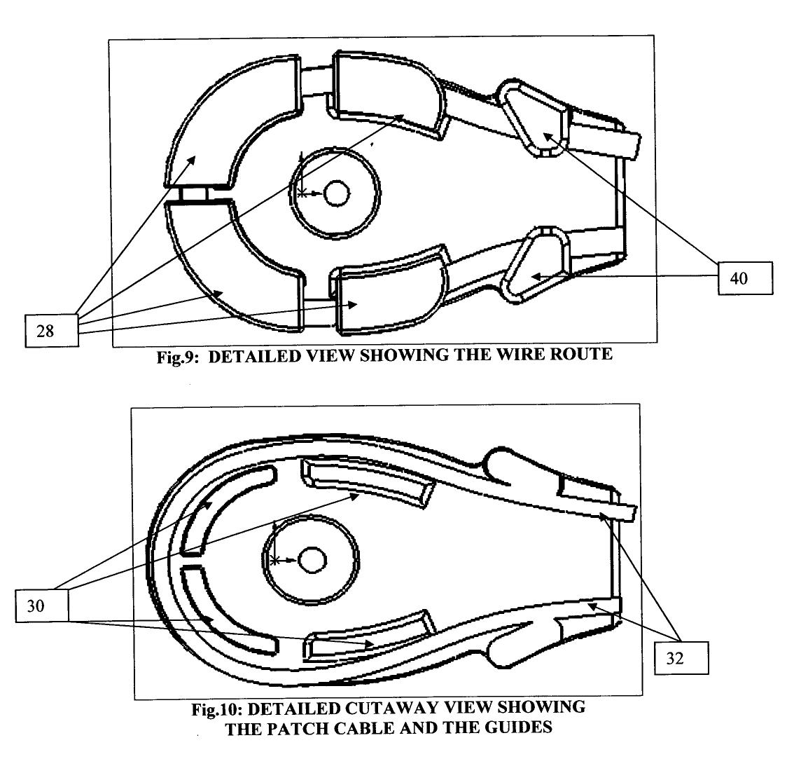

### FIGS. 9 and 10—Additional Embodiments

The cablecure is illustrated with a patch cable 32 positioned and arranged through the Patch Cable Channel Guides 30. The Radial Channels 28, provide additional guidance and a nesting area into which the patch cable 32, rests. The Patch Cable strain relief tabs offsets assist in maintaining the patch cables 32 position and in guiding it away from the cablecure while being a key contact point to relief the torque and strain that may be placed on the patch cable 32.

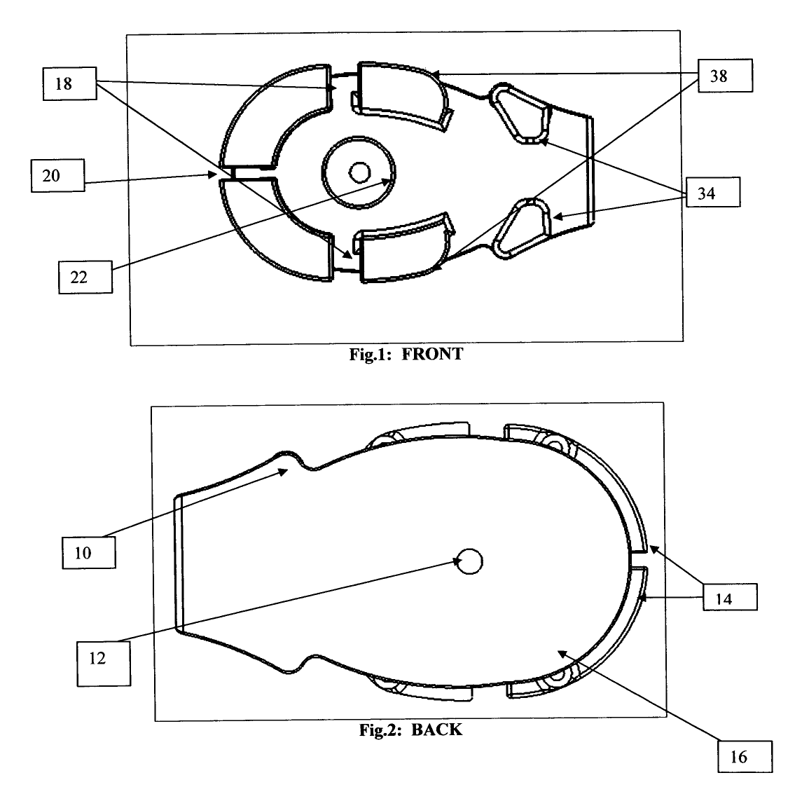

### Operation—FIGS. 2,3,4,9 and 10

The main function of this invention is to eliminate the stress, torque and tension that is applied to a patch cable, the patch cable ends and guitar receptacles (jacks). Additionally the invention prevents the patch cable end from inadvertently being pulled out. When the invention is mounted on a guitar end pin or strap button, via the mounting hole 12 and counter-sunk recess 22, it can pivot freely providing additional relief from the tension created on the patch cable when the guitar player moves around.

The radial channels 28, the patch cable channel guides 30 and the patch cable projections 24, provide a secure capture area for the patch cable and through their design a way for the guitar player to attach the cable with only one hand. The side Flex Gap 18 and central flex gap 20 assist in the absorption of torque and twist on the invention and also enable the invention to accommodate a range of patch cable diameters

The patch cable strain relief guides 34 act provides a major contact point where a great deal of the torque, strain and stress from the patch cable being pulled will be directed and absorbed.

The pick holder 26 is an added feature that provides the active player with a standby pick should he drop or break the one he is using.

### Advantages

a) Provides strain relief to protect the guitar, its finish and surface, its connections, the patch cable, patch cable ends and any electronic or amplification equipment the patch cable may be attached to.

b) Easy to mount with one hand

c) Once mounted, it can remain on the guitar or bas guitar

d) It can endure and diffuse substantial amounts of load due to the central and side flex gap

e) The CableCure is able to endure axial loads better because of the channel guide and patch cable strain relief guides

f) The CableCure has a slot allotted for an extra pick as a backup

g) Its low profile and small size ensures it will not interfere with the normal operating characteristics of any guitar or bass guitar

h) Due to its size and the fact that it will be manufactured from lightweight material, it does not materially affect the overall weight or balance of any guitar or bass guitar

i) Due to its size and that it will be manufactured with light-weight materials, it is cost efficient to ship, handle and store.

### CONCLUSION, RAMIFICATIONS AND SCOPE

Accordingly, the statements on this invention show how this design provides a method to eliminate the strain, torque and tension typically exerted on a patch cable, patch cable ends, the guitar-side receptacle and the amplifier or public address system receptacle. This is achieved through this unique design and the interrelation among the various characteristics of this invention.

Although the description above contains many specifications, these should not be construed as limiting the scope of the invention but merely providing illustrations of some of the presently preferred embodiments of the invention. For example, the round mounting hole can be larger or smaller or it may include relief cuts or slots that enable the cablecure to be mounted to a wide variety of guitar styles and types. In addition the mounting hole could be slotted or angled with a flair end to provide different methods of attachment and detachment. A sliding spring clip attachment could also function as a positive snap-hold to secure the invention to the end pin or strap button. The invention could be manufactured as an injection molded part using PVC, rubber, nylon, glass filled nylon, Delrin, HDME, or any other injectible material. It could also be machined from a block of any of those materials or many others. The choice of materials could be also be adapted depending on color preferences and tastes. In addition, different materials with varying durometer or hardness could be used to achieve different flex or absorption attributes. Thus the scope of the invention should be determined by the appended claims and their legal equivalents, rather than by the examples given.

I claim:

1. A guitar accessory comprising:
a. a radial channel and side channels around which a patch cable can be inserted
b. projections on the radial and side channels that allow said patch cable to be “snapped” into the channel guide area
c. flexible gaps in the channels that enable the accessory to accept different diameter patch cables
d. channel strain relief guides that provide support and points to eliminate strain and torque created when the patch cable is pulled away from the guitar
e. mounting hole with a counter-sunk recess which enables the accessory to be mounted directly under the guitar end pin or strap button.
f. guitar pick holding slots on top of the channel strain relief guides
g. position of radial and side channels and channel strain relief guides that allow guitar player ability to attach patch cable using one hand
h. invention can remain mounted on guitar since its low profile will enable guitar to fit guitar case with the invention attached
